(19) United States
(12) Patent Application Publication
(10) Pub. No.: US 2004/0207581 A1
(43) Pub. Date: Oct. 21, 2004

(54) Modular traveling-message sign apparatus

(76) Inventor: Paul A. Miller, Marshfield, MA (US)

Correspondence Address: REGINA ANN LOUGHRAN, 1675 YORK AVENUE, #10F, NEW YORK, NY, 10128, US

(21) Appl. No.: 10/463,305

(22) Filed: Jun. 16, 2003

Related U.S. Application Data
(63) Continuation-in-part of application No. 10/418,959, filed on Apr. 18, 2003.

(51) Int. Cl. G09G 3/32

(52) U.S. Cl. 345/82

(57) ABSTRACT

A traveling-image sign is disclosed that comprises display columns that are depopulated so that the distances between the columns of light sources that provide the sign's display pixels are substantially larger relative to the distances between the display pixels in each column, than in 1:1 display pixel arrays used in conventional traveling-message signs. Because the 1:1 pixel array seen by the viewer looking at the depopulated sign includes virtual columns, that physical array of display column elements in the sign can be installed as separate, widely-spaced display-column elements in rows of icicles, ceiling fixtures, or banners, as well as being surface mounted in novel, unobtrusive ways. Because the display-column elements are slender and widely-spaced, they be substantially invisible to the viewer. Because the display-column elements are widely-spaced, the individual display-column elements are readily made plug-replaceable. The individual plug-replaceable display-column elements that are interchangeable as well as plug-replaceable are disclosed, which further reduces maintenance costs.

This application is a continuation-in-part of the United States continuation-in-part utility patent application Ser. No. 10/418,959 filed Apr. 18, 2003, a continuation-in-part of PCT utility patent application no. 03/08621 filed Mar. 19, 2003.

### BACKGROUND OF THE INVENTION

1. Field of the Invention

The present invention pertains to electronic display devices. More particularly, the present invention is directed to electronic display devices that use an array having pixels arranged in rows and columns to display information.

2. Discussion of Related Art

Wall-mounted strip signs, such as New York City's famous Times Square “zipper” sign are well known. Display pixels that provide the text and other images are usually electronically-controlled light-sources, but passively-lighted electro-mechanical indicators, liquid crystals, or electrostatically deflected films have also been used. Signs conventionally have the same spacing between pixels within a column as between pixels in adjacent columns of pixels, i.e., a one-to-one pixel aspect ratio (1:1), for the sake of maximum legibility with a minimum number of pixels.

In these traveling-image signs, the entire display pixel matrix is arranged as a succession of columns that extend across the matrix from end to end. The “columns” in a traveling-image sign are linear arrays of display pixels that extend perpendicular to the axis along which the traveling-message image is moving. The length of the rows in a traveling image sign on that axis along which the image is moving, is conventionally much longer than the height of the sign's columns, hence the name “strip” signs. Even when strip signs are vertically mounted, so that the message moves vertically, the short horizontal linear arrays of pixels in the vertically-oriented strip sign are still conventionally referred to as the “columns” in the sign. Each “column” in these signs has from 5 to 200 display pixels.

The light sources used to light moving-image signs may be incandescent lamps, LEDs, LED clusters, organic LEDs, vacuum fluorescent tubes, or gas tubes. The lamp or lamps that produce each display pixel are conventionally mounted together on or in the same planar substrate, typically a circuit board or a punched sheet-metal panel mounted on the wall of a room or on the exterior of a building, and connected together as a matrix or a grid. The signs may be constructed as static-drive matrixes in which each individual display pixel has its own data channel connecting the pixel to a central controller. Alternatively, the pixels may be connected in a grid, so that each data channel provides the same time-division multiplexed (TDM) signal to all pixels in a respective row or column of the grid.

Strip signs displaying colored moving images are constructed by providing a cluster of light sources of different colors in each display pixel, each color in said cluster of different colors being independently-controlled by the matrix or grid to produce respective different additive color combinations in each pixel.

Each of the display pixels in a static-drive strip sign is controlled by an individual switching transistor, or a respective output pin on an integrated circuit package, that is responsive to the data input by the channel. DC power supplied to light the lamps in these static-drive matrix may be chopped to vary the brightness of these lamps. However, static drive structures require a large number (k) of individual control channel conductors, one channel conductor per display pixel: kₘ=xy.

On the other hand, a TDM signal grid requires only a single multiplexed control channel to inject respective TDM control signals synchronously across all pixels in each of the orthogonal elements of the grid, advancing from one channel to the next, sequentially, along each axis of a grid-wired traveling-image sign. Thus only one channel conductor is needed for each row and column in the grid: k_{g}=x+y. Thus the TDM grid is advantageous, in that: k_{g}<kₘ.

When light-emitting diodes (LEDs) are use to light these grids, the anodes of all LEDs in each row are conventionally connected in common to a respective anode-driver channel which selectively enables that row by connecting those anodes to the positive side of the power supply. The cathodes of the LEDs in each column are connected in common to a respective cathode driver channel that selectively connects the cathodes of all LEDs in a respective column to the negative side of the power supply. Thus, each respective row of LED anodes is sequentially driven positive by a respective pulse applied to the anode driver for that row, timed in accordance with the row's position in the grid. The signals applied to the cathode drivers of selected columns in the grid while a given row is enabled by its anode driver, light selected LEDs in the enabled row by completing the circuit connecting those LEDs to the power supply.

Chopped DC cannot be used to vary the brightness of a TDM grid, as it does in static-drive matrixes, since the patterns displayed by these TDM grids are controlled by pulsed signals. Instead, the pattern displayed by the grid is conventionally sequentially repeated, that is “refreshed”, and the number of refresh cycles in which each display pixel on the grid participates for each displayed image can be varied slightly to implement a grayscale in the TDM grid.

The lag interval between the time when pixels in the first and last rows in a TDM grid can be lighted is referred to as the refresh “cycle” for the grid. The lag that occurs as the lamps in each row are lighted in response to serial data inputs, and the rows are sequentially enabled induces a forward “italic” tilt if the last row enabled is at the top row of the grid. However, TDM grids that light the same pattern in at least two sequential refresh cycles, reduce the tilt induced by these response-time lags. Similarly, lighting a TDM pixel grid at twice the conventional refresh rate without increasing the perceived speed of a moving-message image has been used to “compress” the text font displayed by “overpopulating” the grid perceived by the viewer with extra columns, inserting an additional column between the columns of an already full 1:1 TDM pixel, doubling the number of columns forming the rows of pixels that provide the horizontal contours of the font during extra refresh cycles.

Finally, in contrast to these conventional matrixes (xy) and TDM grids (x+y), a columnar (y) device that produces “virtual” pixels, was introduced by Bill Bell some years ago and has been exhibited by many science museums since then. Bill Bell's “light wand” is a stick that carries only a single linear array of very bright lamps. The lamps on the stick flash simultaneously to form a succession of the display-column patterns that, taken together, form a desired text-image matrix although they are only a sequence of one-dimensional column patterns displayed over time. These patterns displayed by the flashing light wand, however, are perceived by the viewer as a sequence of virtual columns that form a static strip sign image.

When a viewer's eyes sweep across Bill Bell's light wand, the image of the flashing wand appears to move across the viewer's visual field as the stationary stick paints an array of brief afterimages on the viewers moving retina. Under favorable lighting conditions, Bill Bell's magic wand produces a virtual pixel matrix that is as clearly readable by the viewer as though it were a static image displayed by a wall covered by rows and columns of lights.

### SUMMARY OF THE INVENTION

The present invention enables display signs to provide the appearance of a one-to-one pixel aspect ratio with fewer physical light sources and a greater distance between the columns. It has been surprisingly found that a substantially transparent stationary display matrix provides a fully-expressed, fully-legible traveling image in accordance with the present invention, even when the columns of the display sign are greatly depopulated.

In accordance with the present invention, multiple adjacent like image-column patterns in each image pattern displayed by the display sign are implemented by each like display column in the display sign by depopulated physical columns in the traveling-image sign, like image-column patterns being image-column patterns of similar-color image pixels. Thus the depopulated physical display-column elements in the display sign can be widely separated, even substantially invisible, and still be operated so as to display the image pattern using substantially a 1:1 pixel-aspect ratio.

The display of multiple image-column patterns in accordance with the present invention by depopulated display-column elements, greatly reduces the number of light sources required to implement a sign, thereby reducing construction costs, the number of elements that require maintenance and replacements.

In a particular embodiment, the timing of the depopulated matrix may be operated to overlay image-column patterns displayed by a given display column using light sources of a given color on image-column patterns displayed by another display column using light sources of another color, so that the overlay produces an additive color in the overlaid columns perceived by the viewer. Alternatively, additive colors may be produced in accordance with the present invention by selectively lighting respective different colored light sources included in each of the pixels. Preferably the respective colors are additive primary colors.

The invention is particularly advantageous for strip signs, that is, signs that are much longer than they are wide, because when these strip signs are depopulated in accordance with the present invention, the wide spacing between these short columns makes the columns especially convenient to replace as a unit.

Preferably, display-column elements in accordance with the present invention are plug-replaceable. In particular preferred embodiments, the plug-replaceable display-column elements are also interchangeable, reducing both stocking and labor costs.

Depopulated signs in accordance with the present invention are advantageous for outdoor installations, in that their display column elements present virtually no resistance to the wind, and little or no surface for collection of ice, snow and rain, compared to the conventional matrixes and grids of similar-size displays.

Moreover, the present invention permits display column elements in a traveling-image sign to be spaced apart so widely as to render the structure of the sign substantially transparent even in day light, thereby minimizing the sign's visual impact on adjacent architectural and display elements and reducing environmental clutter, while still providing a virtual pixel matrix that is readily read by the viewer.

The widely-spaced display-column elements in a traveling-image sign in accordance with the present invention are also suitable for a wide range of outdoor and interior lighting conditions. Highly legible displays having a wide range of depopulation ratios available when corresponding adjustments are made to the sequential timing and brightness of the light sources in the physical columns.

Furthermore, the columnar elements of a traveling-image sign in accordance with the present invention can also advantageously be presented in new orientations and mounted in novel ways. In particular embodiments, display column elements are suspended as a flexible pixel array adapted to be twisted into sideways bent arc shapes where the arc radius vector is not perpendicular to the surface defined by adjacent lamps, or disposed in respective circular and helical array forms.

In one embodiment of the invention, individual columns of the sign are housed in transparent enclosures. Advantageously, multiple columns of light sources inside each enclosure can provide pixels visible in respective different directions. A particular embodiment of the invention provides independently-controlled images on opposite sides of the sign.

A traveling-image sign in accordance with another embodiment of the present invention both displays a traveling image having a wide viewing angle, and selectively displays a static image having a narrow, very oblique viewing angle. In a particular embodiment, widely-spaced depopulated columns are recessed in a wall in a confined space so as to provide a fully-legible traveling-image sign but be incoherent as a static image, because the recessed depopulated matrix cannot be viewed obliquely nor at a distance sufficient to allow the viewer to resolve the image.

### BRIEF DESCRIPTION OF THE DRAWINGS

The features and advantages of the invention will be better understood when the description of presently preferred embodiments, provided below, is considered in conjunction with the drawings provided therewith, wherein:

FIG. 1 is a perspective view of display column elements installed in a traveling-image strip sign mounted near the roof-line of an office building in accordance with a first embodiment of the invention;

FIG. 1a is a longitudinal schematic cross-section view of a plug-replaceable display column element on a mounting box suitable for use in the strip sign of FIG. 1;

FIG. 1b is a longitudinal schematic cross-section view of a preferred display column element and mounting box for use in the strip sign of FIG. 1;

FIGS. 2-2a are a schematic front-elevation and schematic axial cross-section view of the plug-replaceable display column element of FIG. 1a;

FIGS. 2b-2c are axial cross-sections of two-sided display-column elements;

FIGS. 2d-2e are axial cross-sections of four-sided display-column elements;

FIG. 2f is an axial cross-section of an orthogonal two sided columnar matrix element for use in FIG. 1;

FIG. 3 is a perspective view of display column matrix elements installed in a traveling-image strip sign along the roof line of a convention center building in accordance with the first embodiment of the invention;

FIG. 3a is a longitudinal schematic cross-section view of one of the plug-replaceable columnar matrix elements of FIG. 3;

FIGS. 4-4a are a bottom overhead view and lateral cross-section view of a circumferential array of display columns that may be suspended or mounted for providing a circular moving-image strip-sign in accordance with a second embodiment of the invention;

FIG. 4b is a front elevation view of a substantially invisible moving-image strip-sign apparatus including a header box, providing a horizontal or vertical banner in accordance with the second embodiment of the invention;

FIGS. 5a-5b are schematic perspective views of flexible moving-image strip-sign arrays providing banners in accordance with a third embodiment of the invention;

FIGS. 5c-5d are elevational views of the banner of FIG. 5b suspended in alternative ways;

FIG. 5e is a schematic perspective view of a display column in accordance with the third embodiment of the invention;

FIG. 6 is a schematic cabling diagram for the strip sign of FIGS. 1 and 3;

FIG. 6a is a schematic elevational view of a virtual image displayed by display column elements;

FIG. 6b is a schematic block diagram of a micro-processor and cabling for use in FIGS. 5a-5e;

FIG. 6c is a schematic diagram of a stored image pattern for a moving image displayed by display column elements; and

FIGS. 7-7a are schematic front elevation and cross-section views of display column elements mounted in accordance with a fourth embodiment of the invention.

In these drawings, similar structures are assigned similar reference numerals.

### DETAILED DESCRIPTION OF PRESENTLY PREFERRED EMBODIMENTS

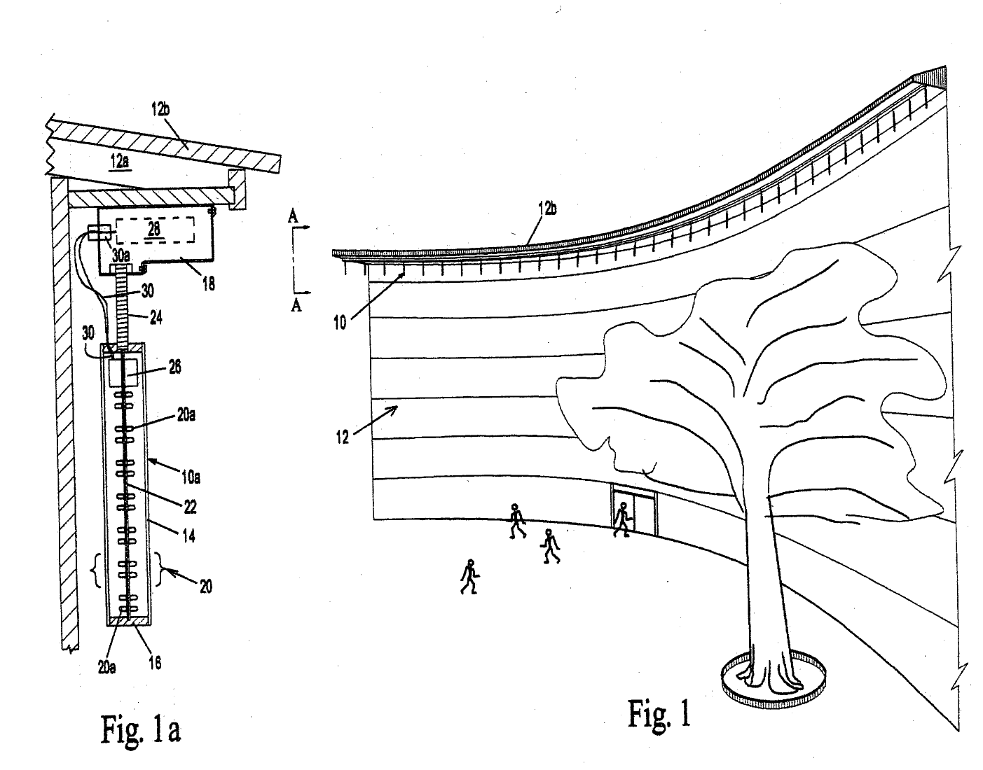

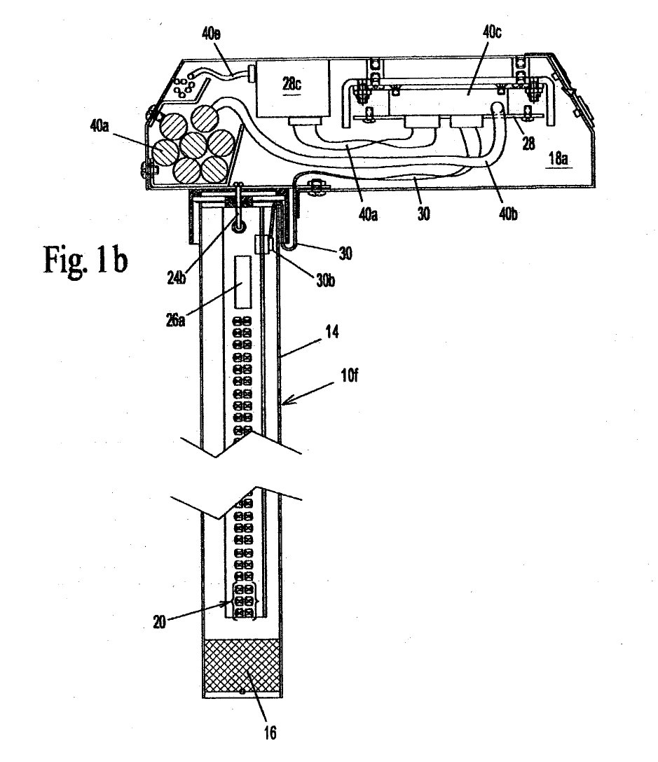

In FIG. 1, a traveling-image strip sign in accordance with the present invention is installed along the horizontal roof line 12b of an office building, about 8 floors (25 meters) above ground level. The display-pixel matrix in this strip sign is made up of 1536 individual display columns 10 that are 11.20 inches (284.48 mm) long and spaced apart at intervals of 5.469 inches (138.9 mm). Each display column has 16 display pixels spaced 0.70 inches (17.78 mm) apart. The light sources that provide the display pixels 20 in each of the columns are preferably respective groups of LEDs 20a mounted on a printed circuit board 22, as shown in FIGS. 1a and 1b.

Preferably, in such high-elevation outdoor installation shown in FIG. 1 the LEDs 20a and the circuit boards 22 in each display column element 10 are enclosed in transparent plastic tubes 14 that are about 14 inches long (356 mm) and 2 inches (50.8 mm) in diameter. Also, these display column elements 10 are substantially evenly distributed over a distance of 700 feet (213.37 m) across the front of the building 12, in FIG. 1, spaced apart on 5.469-inch (138.91 mm). The physical distances between individual display column elements 10 may be adjusted during installation to accommodate the dimensions of structural features of the building 12.

As each display column 21 in the sign displays the next image-column pattern, the sign provides a 0.684-inch (17.36 mm) perceived pixel pitch within each row between the display pixels in each physical display column 21 and the display pixels in the seven virtual display columns that are seen by the viewer as located between the physical display columns 21 at that moment. Thus, the perceived pixel pitch between the display columns seen by a viewer in FIG. 1 is substantially equal to the physical 0.70-inch (17.78 mm) spacing between the physical display pixels 20 within each physical display column 21 in one of the physical display column elements 10.

The rule-of-thumb “depopulation ratio” for this one-color traveling-image sign is 8:1, that is, eight columns of the displayed image pattern are output to the viewer by each display column in the display sign in the time it takes an image-column pattern to travel from one display column 21 to the next display column 21. Thus the depopulation ratio value (r) for this display sign is (r=8). Because, in accordance with the invention the traveling-image display of FIG. 1 includes both virtual and physical display-pixels, it displays (8xy) image pixels but contains only (xy) pixels, and in the example described above: x=1536 and y=16.

On the other hand, the physical pixel-aspect index (p) for this one-color traveling-image display sign compares the average inter-pixel spacing within each physical display column 21 to the average inter-columnar pixel spacing between physical pixels 20 in each row. This indicates the degree of overpopulation Of depopulation in the sign relative to conventional 1:1 pixel spacing. If the intra-columnar pixel spacing value is 0.700, and the inter-columnar spacing value is 5.469, then p=0.128.

In displays provided in accordance with the present invention, the depopulation ratio value (r) and the physical pixel-aspect index (p) are widely variable, as is discussed further below. In the installation described with reference to FIG. 1, the values r=8 and p<1/7 were determined to be the optimum for the operating-efficiency and aesthetic requirements of that particular installation. In this installation, the virtual pixel-aspect index (v=rp) is substantially the same (v=1.024) as that of a conventional 1:1 display where (v=1).

Display Column Elements

In FIG. 1a, the display column element 10 comprises a clear plastic tube 14 closed by attachment hardware 24 at one end, and a strainer plug 16 at the other end, which prevents dust and insects from obscuring the pixel light sources 20 in the display column 10, and also protects the light sources 20 and their connections from harsh weather conditions. The display column elements 10 hang like “icicles” from a header box 18 that is attached to the soffit 12a of a roof 12b such as that shown in FIG. 1. In FIG. 1a, the four LEDs 20a in each pixel 20 are mounted on both sides 21a, 21b, of a single two-sided printed circuit board 22, such as that shown in board 28 in the header box 18, by a cable connector 30a containing a plurality of ribbon-cable conductors 30. Each of these conductors 30 is connected to supply power to a respective pixel 20 on the printed circuit board 22 so that the LEDs 20a in each pixel in a given display column 21 are independent of the LEDS 20a in other pixels 20 in that given display column 21.

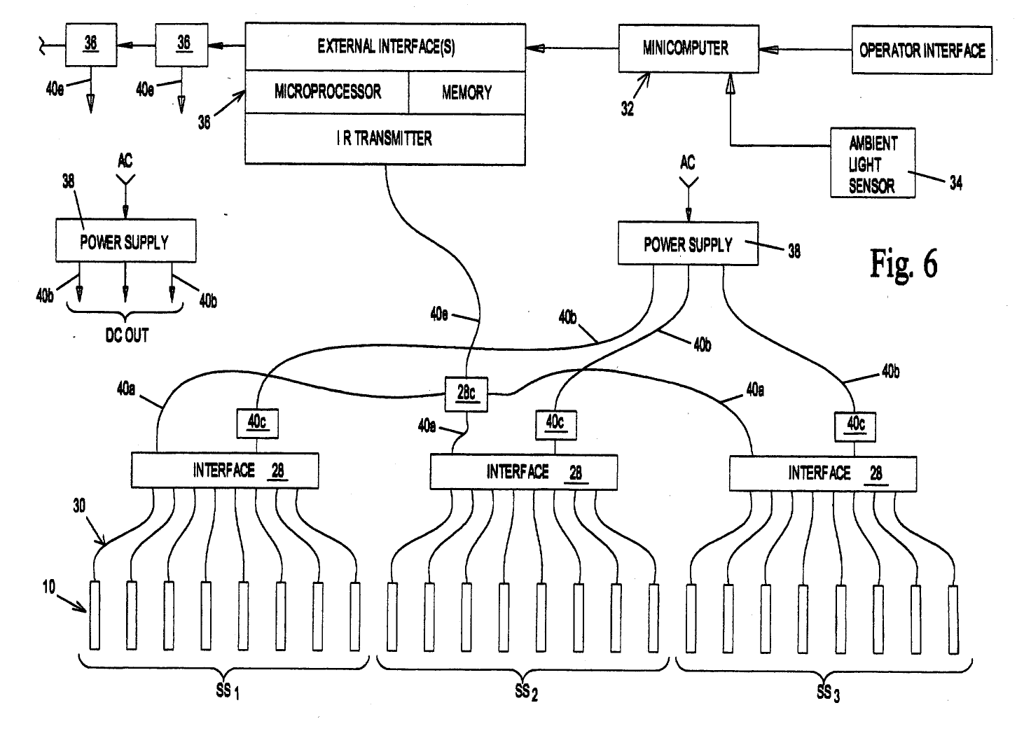

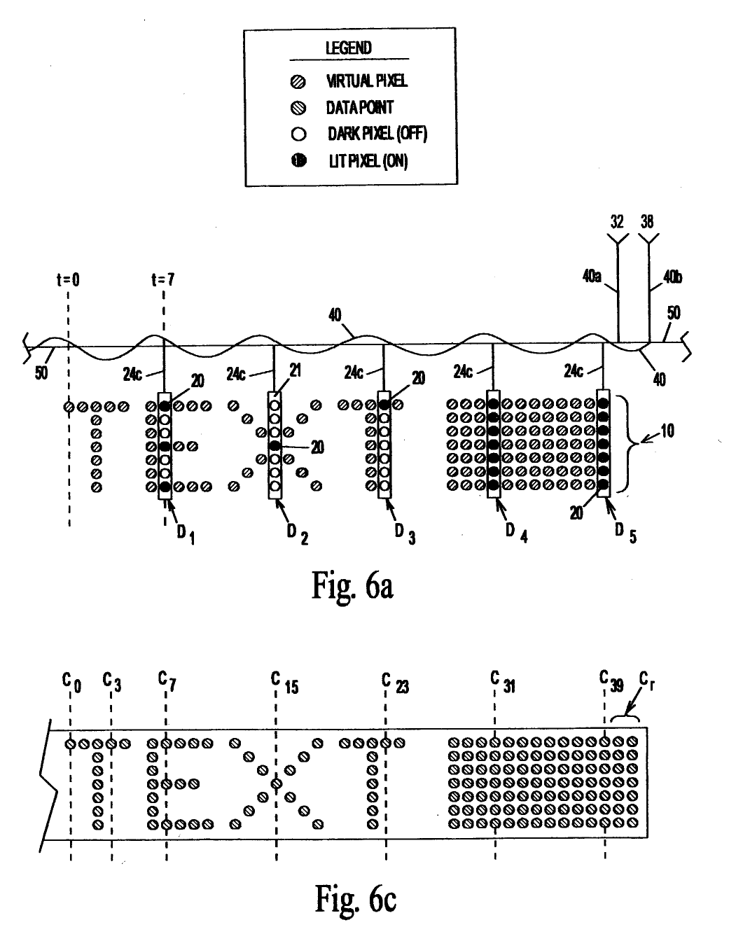

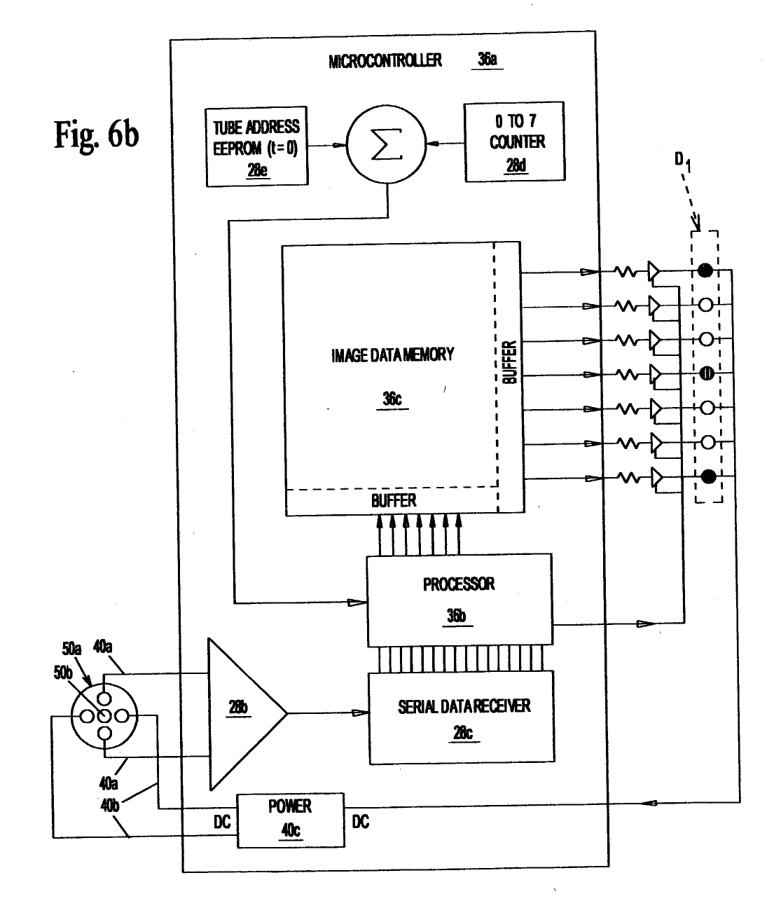

In FIG. 1b, the presently preferred “icicle” display column element 10f is rigidly held in place against another header box 18a by a bail wire 24b. The conductors 30 connect to the circuit board through a table connector 30b. The cabling inside the header box 18a in FIG. 1b is further described below with reference to the cabling diagram FIG. 6. In FIG. 1b, the conductors in the connector 30 provide ground, DC power, serial data, serial clock, and latch enable signals. Respective inputs on two integrated circuits (ICs) 26a are connected in parallel to these conductors 30, one for each interdependent display column 21a, 21b, on the circuit board 22. Each IC 26a has eight outputs connected to sink current through a respective one of eight pairs of parallel-connected pixel halves in each display column 21 to ground.

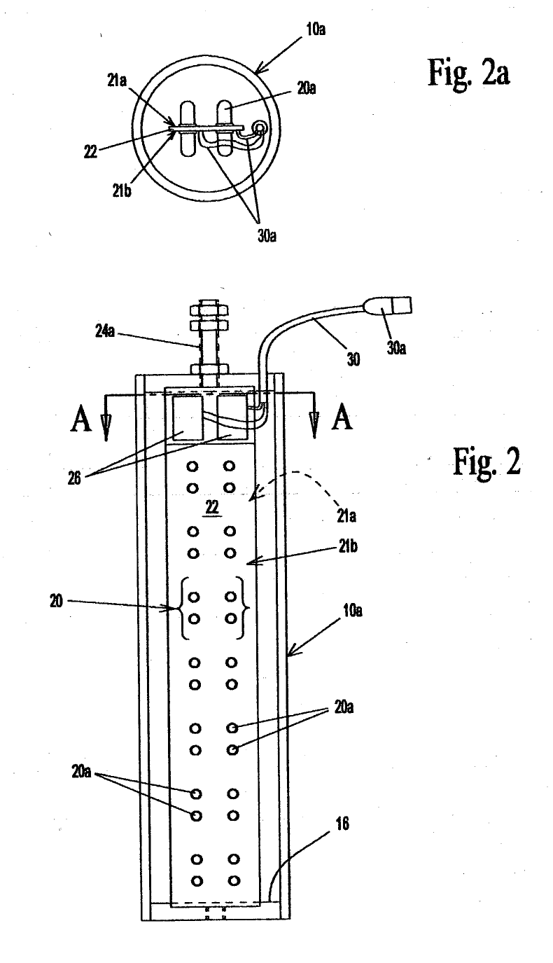

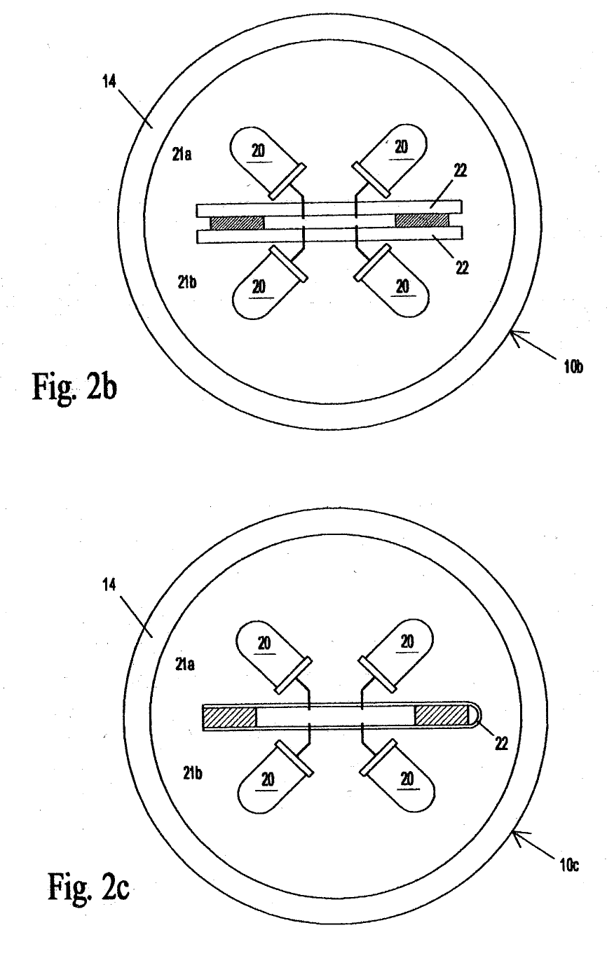

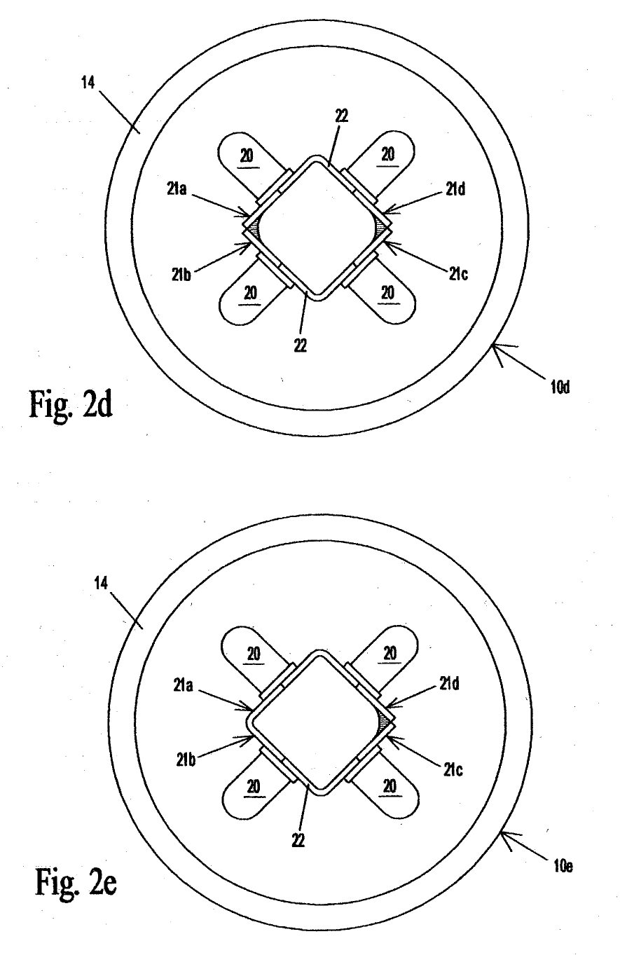

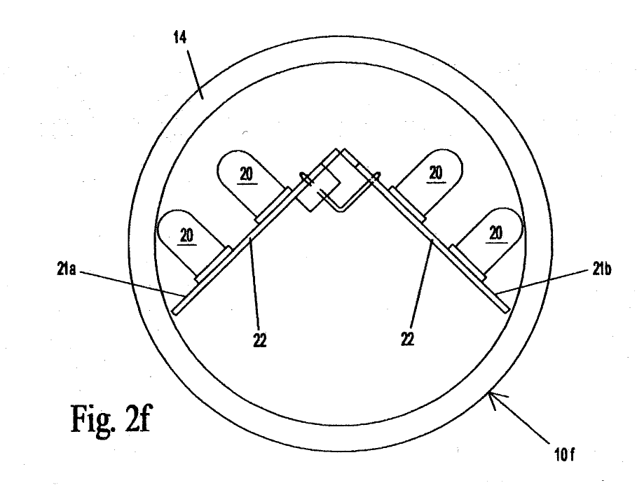

In the unmounted plug-replaceable display column unit 110a shown in FIGS. 1a, 2, and 2a, the mounting hardware 24 is a rigid threaded stem, and the connector cable 30 comprises two ribbon cables and a plug 30a that permits the display column element 10a to connect to the interface 28. Each of the two ribbon cables supplies switched power to a respective one of the two rows of LEDs 20a on the side of the printed circuit board 22 shown in FIG. 2.

In FIG. 1a, all LEDs 20a within each pixel 20 in the column 21a are lighted simultaneously, but using two cables 30 to light respective halves of each pixel provides redundancy within pixels that is advantageous in signs that are not readily accessible for maintenance, driving the remaining one half of the pixels 20 in the column 21a if a circuit driving LEDs 20a in the other half of one or more of the pixels 20 in that column 21a fails. The LEDs 20a in each corresponding pixel 20 in the column 21b on the other side of the display column element 10a may be driven by the same data signal conductor as the corresponding pixel 20 in other column 21a, or independently driven by additional conductors provided in the pair ribbon cables 30. If the two columns are independently driven, they may be driven by copies of the same pattern or by respective different patterns.

Preferably, however, the display column elements 10f shown in FIG. 1b are installed in the roof-mounted sign shown in FIG. 1. These display-column elements 10f, include twelves LEDs 20a (six not shown) in each pixel 20. All twelve are preferably driven by the same data signal, for the sake of simplicity, when the display-column elements 10 in an installation are plug-replaceable and readily accessible for maintenance, as in FIG. 1.

In the particular display-column element 10f shown in FIG. 1b, six of the LEDs 20a in each pixel 20 face leftward toward the beginning of the text message at approximately a 45-degree angle to the building's facade 12 providing a first interdependent display column 21a in FIGS. 1b and 2f. The six other LEDs 20a in the other half of the pixel 20 provide a second interdependent display, column 21b facing rightward toward the end of the text message, at a 90-degree angle to the other display column 21a. If less brightness is desired, fewer LEDs 20a may be used in each pixel 20, as shown in FIGS. 1b-1c or even single lamps may be used for each pixel 20, as indicated schematically in FIGS. 2b-2d.

Virtual Pixels

It is well known in the art that, a frequency of at least 30 Hz is sufficient to control image flicker in traveling-image signs, for the sake of legibility. Practically speaking, this means that each image column in the pattern seen by the viewer must be re-displayed, wherever it has advanced to on a traveling-image sign, at least 30 times-per-second (a 30 Hz refresh rate).

In FIG. 1, however, before the image-column patterns displayed by any display-column element 10 can be refreshed, they rust advance across seven virtual display column locations to the next physical display column in the traveling-image sign, unlike conventional traveling-image matrixes and TDM grids. Thus, the physical display columns 21 must flash at eight-times the refresh rate. Each display column in the traveling-message strip sign shown in FIG. 1 is preferably operated at an image-column advance rate of 240 to 360 image-column patterns per second. Image-column advance rates as low as 260 Hz (a 32.5 Hz refresh rate) have been found to provide satisfactory legibility in the installation shown in FIG. 1. Slower refresh rates, as low as 24 Hz have acceptable flicker and allow the image to travel as slowly as 3.33 n/sec. across the traveling-image sign shown in FIG. 1.

Preferably, each of the twelve LEDs in each pixel in FIG. 1b is a 63-milliwatt red LED 20a. In bright sunlight, pixel switching in FIG. 1b is timed to provide the maximum possible duty cycle for the pixels that are on, close to a 100% duty cycle when the pixel is constantly on. The duty cycle of the lighted LEDs 20a is then reduced to the minimum practicable time when sky becomes dark and night falls.

In order to avoid perceptible flicker in an array of physical and virtual pixels perceived by the viewer, the energy delivered to the viewer's eye must also be sufficient to form a pixel image on the retina that has sufficient persistence to bridge the intervals when energy is not being delivered. Thus, a wide range of depopulation ratio values (r) that display more or fewer image column patterns (C) using a given number of physical display columns, can be implemented if the brightness and duty cycle of the light sources are adjusted to compensate for any change in the amount of energy delivered to the viewer's eye for each image-pattern pixel by each display column.

In particular, the timing changes that change the number of virtual columns produced by the display sign will change the image-column refresh rate, and may force a change in the duration of each image-column display. However, adjusting the duty-cycle of the light sources, and also modifying their brightness by modifying the power supplied to the light sources in the display if further adjustment is necessary, readily compensates for these display-timing changes in accordance with the invention, in addition to compensating for lighting changes in the environment.

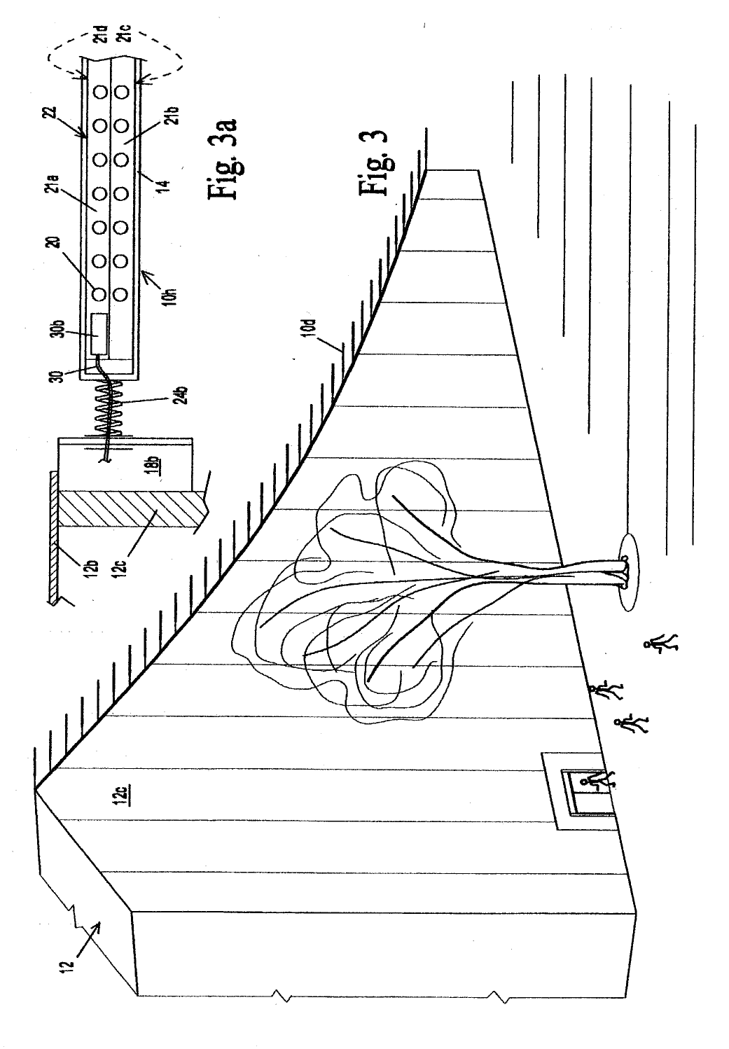

FIGS. 3 and 3a show an alternative roof line installation of the display column elements 10h along the roof line 12b, that simultaneously directs images upward toward the upper floors of adjacent office buildings on one side, side wise down the street on the other side, and downward toward pedestrians, without obscuring the facade 12c of the building 12. The pixels 20 in the display columns 21a, 21b, 21c, 21d that provide this 360-degree viewing angle are again preferably respective groups of LEDs 20a that are enclosed in tubes 14. However, the LEDs 20a in these display column elements 10h are mounted on a four-sided support, such as the four-sided circuit boards 22, shown in FIGS. 2d-e. Also, since the columns project out from the building parallel to the ground, they are mounted on resilient “breakaway” links 24b, that flex rather than break in the event of an impact.

Concealed-cable Installations

The traveling-image sign installation shown in FIGS. 1 and 3 preferably would have about 1536 display column elements 10 with twelve LEDs per pixel, six in each interdependent column, and a physical pixel-aspect index (p<1/7). In FIG. 1, if the six LEDs for all 16 interdependent halves of the display pixels 20 in each of two display columns 21a, 21b, in each of 1536 display column elements 10 are fully lighted, each display column element 10 will pull 12 watts. Thus, the power source for the traveling-image sign shown in FIG. 1 requires capacity equivalent to the output of eight 3000-watt 48VDC telecom power supplies 38, when conventional losses occurring in power distribution and power conversion are also considered.

FIG. 6 is a schematic diagram of a preferred distributed-control cabling system for distributing power and data in the traveling-image strip signs shown in FIGS. 1 and 3. Each of the eight 3000-watt supplies 38 distributes power to the display column elements 10 via 12 branch circuits 40b, each fused at 12 amperes, with each branch circuit 40b feeding 16 tubes via respective 48VDC to 15VDC converters 40c in the header box 18 on which the display-column elements 10 are mounted.

The master controller 32, preferably server computer or a personal computer (PC), controls the traveling image displayed by display-column elements 10 in the strip sign and varies the brightness of the sign to accommodate changing lighting conditions in response to a suitable ambient light sensor 34. Preferably each display interface 28 serves 16 display-column elements 10 that each have two inter-dependent display columns 21a, 21b, as described above, and three of these interface boards 28 are connected to each of 32 micro-controllers 36. Frame-by-frame image-pattern data output from the master controller 32 is carried by 32 fiber optic channels 40a at 500 Kbps each, an overall data transfer rate of 16 Mbps.

For the sake of reliability and security, the 3000-watt power supplies 38, the master controller 32 and the 32 micro-controllers 36 are preferably rack-mounted and located in ventilator rooms on the horizontal roof of the building shown in FIG. 1. The 96 display interfaces 28 are preferably distributed along the length of the roof line 12b in the header box 18 and are connected to respective micro-controllers 36 and power supplies 38 by fiber-optic cables 40a having IR interfaces 28c, and by copper power cables 40b; respectively. Alternatively, under the slanted roof shown in FIG. 3, the 32 local micro-controllers 36 may have to be installed in a room on the top floor building that is as close as possible to the injection end of the strip sign. The “injection end” of a traveling-image sign is the end nearest the end of line of text in the image that is read by those viewing the strip sign. This environmental difference may require modification of the data and power distribution system shown in FIG. 6, as is discussed further below.

In FIG. 6, preferably each fiber optic cable 40a serves 48 tubes and carries serial data at approximately 500 Kbps or 50K bytes per second, of which about 40K bytes per second is needed for image data displayed at 400 image-column shifts per second in a 48-column segment. The 10K of channel capacity remaining in each cable carries the embedded commands that set operating parameters, such as the brightness required by ambient lighting conditions. Preferably all 32 micro-controllers 36 will be collocated in a single card cage chassis, with four micro-controllers 36 on each card, so that printed circuit traces and backplane connectors provide all the interconnects between the cards. This compact installation of the sign's principal power and control devices provides a particularly favorable operating and maintenance environment that can reduce the risk of equipment failure causing one or more segments of the sign to fail, to no more than a remote possibility.

Free-space Installations

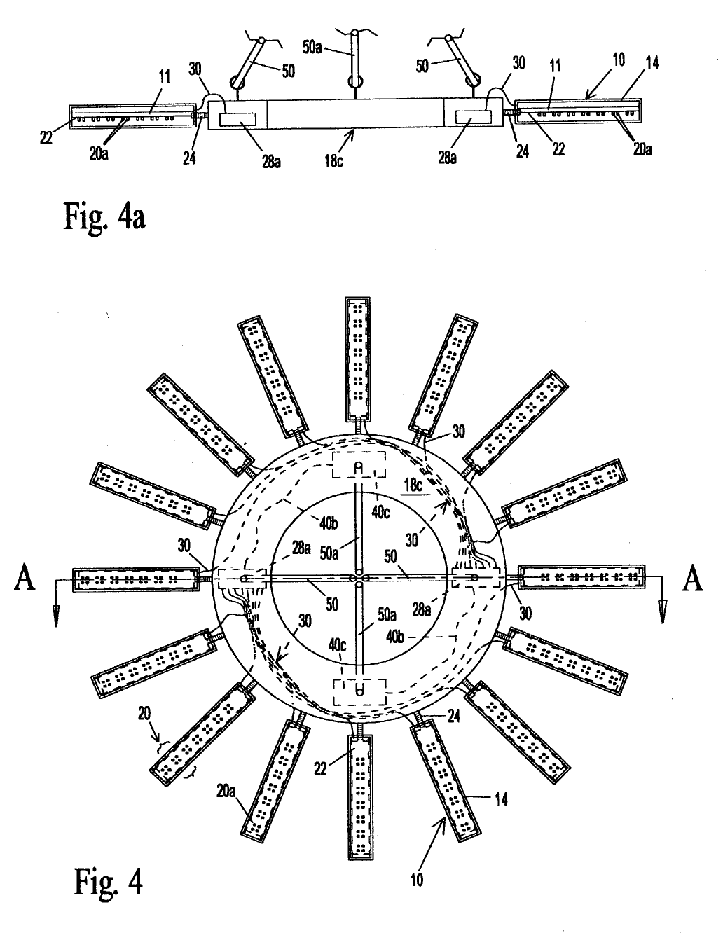

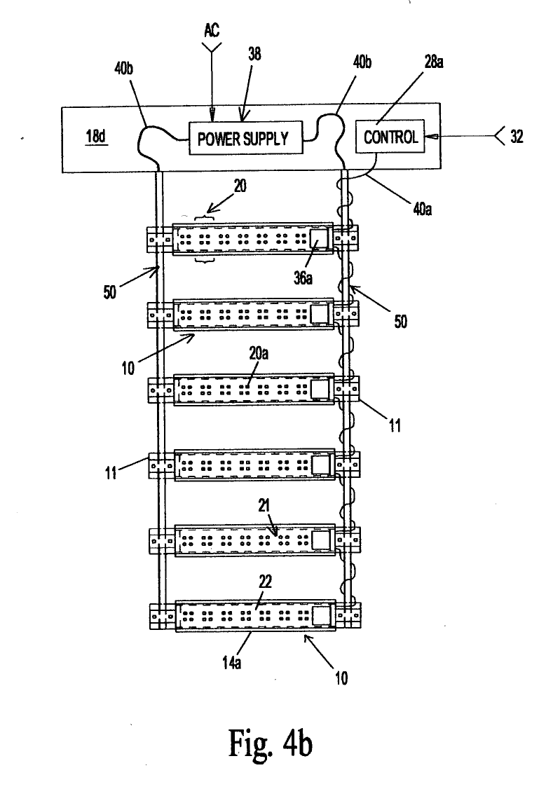

FIGS. 4-4b show display columns 21 that are supported by beams 11, in accordance with a third embodiment of the invention. Preferably the pixels on each beam 11 are protected either by a tube 14, or by a clear snap-on enclosure 14b that encircles the display column or columns on each beam 11.

In FIG. 4a the beams 11 are mounted on a rigid ring-shaped enclosure 18c. The enclosure 18c is adapted to be hung indoors from a convention-hall ceiling on wires 50, 50a. The enclosure 18c provides one interface 28a for each group of eight display column elements 10. Since, unlike FIG. 1, there will likely be no close-by, secure operational environment for this sign's power supplies 38 and controllers 32, 36, DC-to-DC step-down power converters 40c are concealed on the top of the enclosure 18c. The data interfaces 28a serve as both a RF or IR data receiver 28c and a micro-controller 36, driving each pixel 20 in the display column elements 10 through respective conductors in respective connectors 30.

The physical pixel-aspect ratio between these radial display columns varies from row to row. However p≦½ regardless of the aspect ratio of the row nearest the center, since the physical pixel-aspect index quantifies the ratio of the average intra-columnar distance to the average inter-columnar distance.

Similarly, in FIG. 4b, the display columns 21 are suspended from a header box 18d. Display columns 21 on circuit boards 22 in the display-column elements 10 of FIG. 4b are supported by beams 11 on slender parallel beams 50 that support the rungs 10, and power 40b and data cables 40a that connect micro-controllers 36a in the rungs 10 to an AC source and to inputs from the master controller 32 through the header box 18d, providing a stable, low-visibility ladder-like sign structure. Alternatively, instead of distributing data and power in separate cables 40a, 40b, the header box 18d may drive each pixel 20 in the display column elements 10 through respective conductors in respective connector cables 30, as in FIG. 4a.

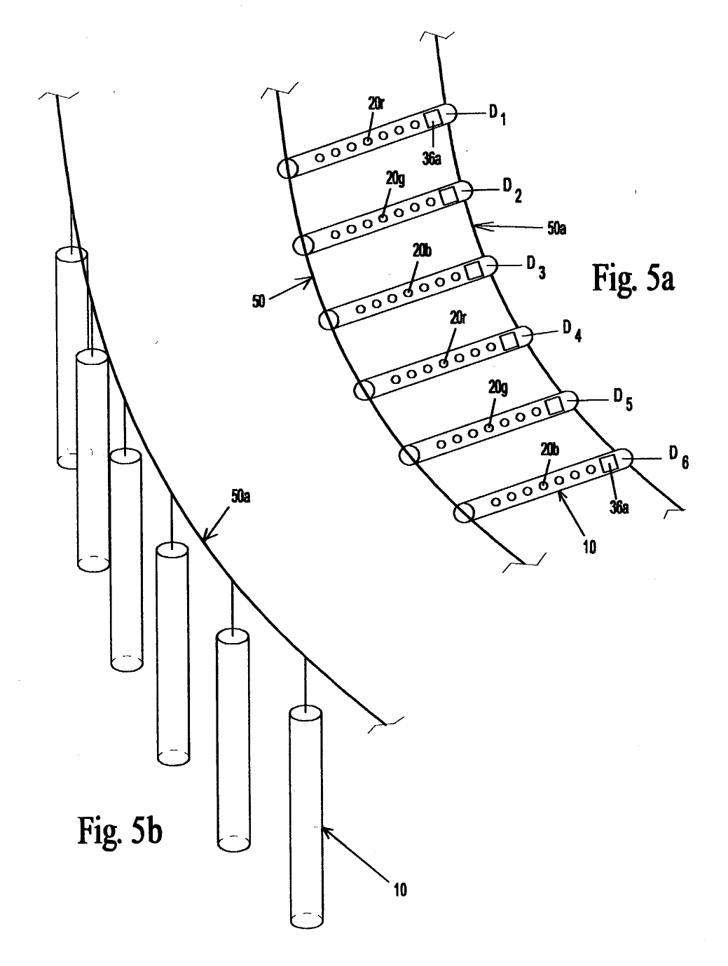

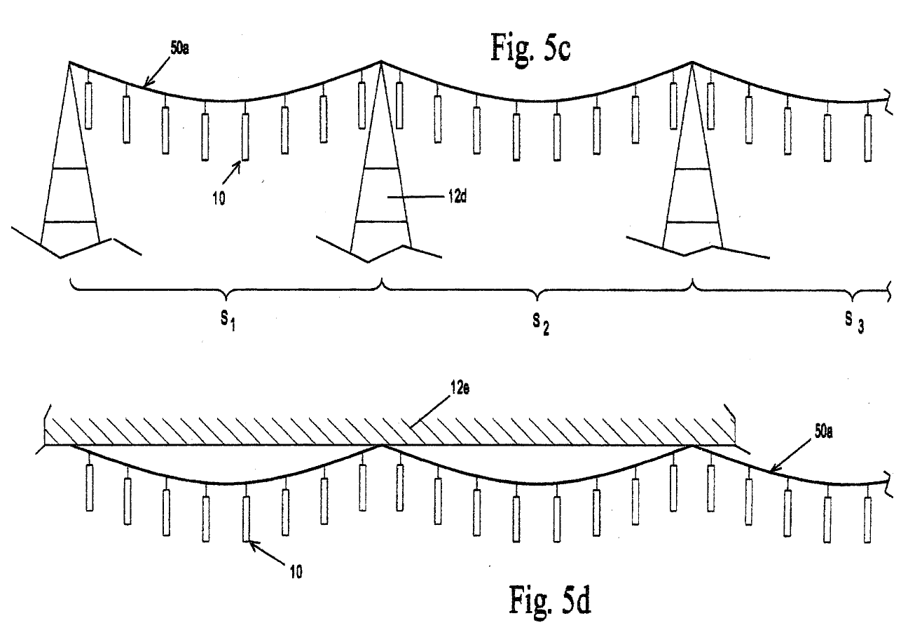

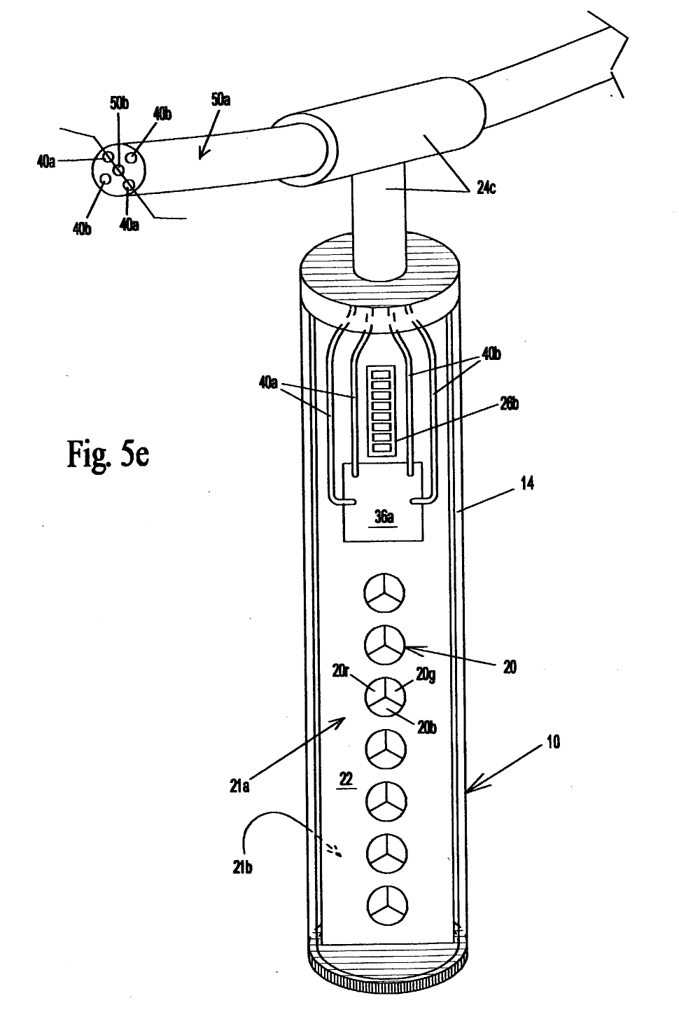

In FIG. 5a, both ends of the display columns are suspended from parallel cables 50, 50a that provide support and power, in a structure that is similar to a rope ladder. This rope ladder can be draped as a vertical or horizontal banner outdoors or in a large indoor space such as a convention hall. Alternatively, each of the display columns 10 may be configured as “icicles” at one end from a single catenary wire, as shown in FIGS. 5b-5d.

Moreover, in FIG. 5a, the display columns in respective display-column elements 10 provide all red (20r), all green (20g) or all blue (20b) pixels, respectively. Sequences of pixels of each color, provide respective color-separation images. Overlaying these color-separation image patterns in proper registration produces an additive, three-color traveling-image display pattern. Preferably the depopulation ratio value (r) for each of these color-separation image patterns is such that (r) is an integer (n) multiple of three (r=3n), so that the display column elements can be evenly spaced. Furthermore, independently varying the duty cycles of the drive pulses supplied to each red (20r), green (20g), and blue (20b) pixels permits a wide spectrum of colors to be displayed by each pixel perceived by the viewer.

Distribution Channels

Although the flexibility and great transparency of a depopulated array of display column elements provided in accordance with the invention is particularly advantageous for implementing free-space traveling-image signs, the free-space environment is more hostile to the operation and maintenance of traveling-image signs. In particular, keeping the hundreds of tiny ribbon cable conductors that attach pixels 20 to their driving signals in FIGS. 1a-1b and 2a-2b well-connected, protected, and invisible, is not economically feasible in FIGS. 5a-5d. It is also harder to protect the power and control circuits of these signs because little or no support and protection is available for their connectors and connections. Therefore, using a daisy chain to pass data between display columns in this third embodiment of the invention risks allowing small failures to disable large portions of such signs.

For the sake of reliability, power for the free-space traveling-image signs of FIGS. 5a-5d is preferably provided as a low-voltage DC current supplied at a high current level through a pair of copper conductors 40b. The cables 50a carrying these conductors 40b may each have a steel support wire 50b, as in FIGS. 5e and 6b, or the conductors may be wound about a slender beam 50 that supports them and the display-column elements 10. Image and control data may then either be multiplexed onto the power conductors 40b as a modulated high-frequency carrier, or sent to the display column elements 10 on respective small data wires 40a.

In FIGS. 5a-5d, since there is no place where the power sources 38, data cables 40e and interface circuitry 28 of FIG. 6 can be concealed in proximity to the display columns 21, micro-controllers 36a are provided for each display-column element 10 in FIGS. 5a through 6b. The lower the bandwidth required to transmit data to each micro-controller 36a in these “smart icicle” free-space installations, the smaller the cables 50a and the longer the data conductors 40a can be, and the more reliable the data may be.

The total bandwidth of the data that is distributed to the “smart icicle” display elements 10 is greatly reduced, relative to the bandwidth required for micro-controllers to provide respective drive signals to multiple display-column elements 10 in FIG. 6, if the same data signal is transmitted to the micro-controllers 36a in all the display-column elements Dₙ, as in FIG. 6a. Furthermore, if the data transmitted to the micro-controllers 36 or 36a includes only a next image-column pattern needed to advance the positions of image patterns already stored in memory, and the basic timing pulses and brightness control data for use by the micro-controllers 36, 36a, the bandwidth requirement for data transmission the needed is reduced in FIG. 6 and further reduced in FIG. 6a.

For a one color sign having 16 pixels per column and one column per tube, if only new column patterns are injected into a sign segment at one end of the sign via a single serial channel and passed from one sign segment to the next, as in FIG. 1, cable runs and bandwidth are both less than would be required to supply entire image patterns directly to the display-column elements 10 or directly to the micro-controllers 36. For example, in FIG. 6, if 800 bytes are transferred per second (400 image-column pattern shifts per second, times 2 bytes per column), with 10 bits per byte the total data transfer rate of 8 Kbps can be transmitted in a 9600 baud channel with room to spare.

Similarly, using the “smart icicle” data distribution approach; wherein a single column is transmitted to all the display-column elements and an entire image pattern is stored by the respective micro-controllers 36a in each “smart icicle.” A 9600-baud channel is sufficient. This is highly advantageous for installations where cabling cannot be concealed, e.g., the banner installations of FIGS. 5a-6a where both the sign and its cabling are preferably transparent, even though “smart icicle” display-column elements containing individual micro-controllers 36a will be more expensive to manufacture than the simpler “dumb icicle” display-column elements. The display-column elements 10 shown in FIGS. 4a and 4b may also be connected only to power conductors 40b, and include micro-controllers 36a that receive a data carrier frequency that is multiplexed on the power conductor, or transmitted as a wireless IR of RF signal.

Many well-known multiplexing technologies, both wired or wireless, can reliably provide a 9600-baud channel bandwidth, thereby eliminating much of the cabling shown in FIG. 6. For example: RF antennas and IR detectors can be used to pickup broadcast RF or IR carriers that eliminate cabling. Puncture contacts and inductive or capacitive pickups can be used in a manner well-known in the art for detecting data multiplexed on power conductors to provide a reliable total data transfer rate of 9.6 Kbps, without providing a separate data conductor.

FIG. 5e shows a display column element 10 constructed in accordance with this third embodiment of the invention, an element 10 for a traveling-image sign that is adapted for installation as a banner suspended in free space. Preferably each display column 21 in these elements 10 has its own micro-controller 36a, and each micro-controller 36a is connected to the master controller 32 (not shown) by a wireless link or by discrete wired connections 40a.

In the sign shown in FIG. 6a, a respective first pair of data wires 40a connects each micro-controller 36a in the display column element 10 to the master controller 32 and a second pair of wires 40b connects the micro-controllers 36a (not shown) to the power source 38, through the housing and connectors provided by column-attachment hardware 24c. Alternatively, if the data channels are multiplexed onto the power conductors 40b supplied to each display column in a suitable manner that is well-known in the art, or received by wireless transmission, only one pair of conductors is needed.

In the particular embodiment shown in FIG. 5e, however, each pixel 20 is made up of closely-spaced colored LEDs that each produce a respective one of three additive primary colors: red 20r, green 20g, and blue 20b. In FIG. 5e, the LEDs of each color 20r, 20g, 20b, are driven by a respective wired or wireless data channel so that each pixel 20 displays the full range of additive color combinations without being overlaid by virtual pixels. Again, as in FIG. 5a, independently varying the duty cycles of respective drive pulses that drive the red 20r or the green 20g, or the blue 20b LEDs in each pixel permits a wide spectrum of colors to be displayed by the pixel 20.

Image Data Distribution

Image-pattern information supplied by a controller to each physical column 21 in the sign or a segment (S) or sub-segment (SS) of the sign may be specific to each single column, or to the combination of columns within a segment or sub-segment of the sign, or be the same for all. Data bandwidth is a critical constraint affecting the implementation of large traveling-image signs, although general-purpose computers and monolithic digital control devices 32 provide multiple serial input-output (I/O) ports, even 32-bit and 64-bit parallel output bus structures that can be configured to shift image-segment patterns into and out of memory in parallel are available.

If the data transmitted by the master controller 32 each time the stored traveling-image is advanced provides a respective single new image-column pattern Cₓ, instead of image-patterns (C₀ to C₃₉) or image-segment patterns (SC₀ to SC₃₉), and the micro-controllers store respective image patterns or image-segment patterns and shift each new image-column pattern across its respective stored image pattern or image-segment pattern, the bandwidth required for each link in the control system is greatly reduced. There are two principal approaches to shifting image patterns in this way, piecewise:

1) Indirect Increment: Each micro-controller 36 may store only the image-segment pattern (Sₙ) that it actually sends to its display columns 21 and hand off image-column patterns to the micro-controller 36 serving the adjacent display segment on its downstream side, as is described above with reference to image-segment patterns. The delay then comes from a combination of the memory location within the local micro-controller 36 that corresponds to the display column and the summed transit delays incurred by image columns input to the local micro-controller 36 as they pass through the memories of upstream micro-controllers 36. For example, in FIG. 6, the micro-controller 36 that is connected to the rightmost display column elements 10 is fed new image-column patterns by the master controller 32. Each micro-controller 36 in the chain of micro-controllers, stores at least the 384 that is displayed by its 48-element display segment, but displays only every eighth image-column pattern from that 384-column image-segment stored in its memory at any given instant.

2) Direct Increment: Alternatively, all the micro-controllers 36 in FIG. 6 may be configured to store the same new image-column pattern data each time they display a new stored image-column patter, each micro-controller 36 receiving the new data directly, instead of along a daisy chain. This provides some redundancy that allows the operation of the downstream-end of the sign, to be immune to effects of transient upstream data problems. However, each micro-controller 36a in this alternative data distribution system must include an image-pattern memory space large enough to hold and appropriately delay the display of all the image-column patterns injected upstream from the given display column 21 in the given display sign or display-sign segment (Sₙ) supplying data to the display-column element where that micro-controller 36a is located, since there is no daisy-chain hand off of data to provide the necessary delay.

Indirect Data Transfer in FIG. 6

In the concealed-cable installations shown in FIGS. 1, 3 and 6, and other installations where cable runs are readily supported and concealed, a different image-column pattern (FIG. 1a), or data for a different image-column pattern (FIG. 1b) is supplied by a micro-controller 36 for each respective segment (Sₙ) of the display sign through respective interfaces 28 to each display column 21 in the display-column elements 10 in the respective sub-segments therein (Sₙ=SS₁ to SSₓ). In such installations, the master controller 32 preferably supplies one new image-column pattern to the micro-controller 36 for the segment (Sₓ) at the injection end of the display sign. The micro-controller 36 for that segment (Sₓ) supplies the oldest image-column pattern stored at the leading edge of its stored image pattern to the micro-controller 36 for the next segment (Sₓ₋₁), and so on down the daisy chain.

Thus, in these concealed-cable distribution systems, an image segment pattern received and displayed by the display segment (S₁) farthest from the injection point will be a delayed version of an image-segment pattern previously supplied to the display segment (S_{X}) nearest the injection point. An exception to this sequentially-delayed hand-off of data supplied by the master controller 32, is the hand-off of system-command data such as brightness control signals supplied by the master controller 32 in response to the light sensor 34 to compensate for changes in ambient light. Such system commands are preferably supplied to the first micro-controller 36 in the daisy chain by the master controller 32, for the sake of simplicity, but immediately and directly passed on intact by each micro-controller 36 to the next micro-controller 36 in the daisy chain along the backplane connection of the card chassis without being delayed. Thus, unlike new image-column patterns, those system commands are passed immediately down the daisy chain.

The relative position of a given image-column pattern in the respective image-segment pattern (Sₙ=S₁ to Sₓ) stored in each micro-controller's memory, preferably corresponds to the relative physical offset of the corresponding display-column element 10, i.e., the number of display column elements 10 between it and the display-column element 10 in that display segment that is nearest to the injection end of that segment (Sₙ). Conversely, within the respective display segment served by each micro-controller 36, the relative offset of the particular display column 21 that is to display a given image-column pattern can be inferred from the relative position of that image-column pattern within the stored image-segment pattern. The physical offsets are determined at the time of installation by the cabling installed between the each display element 10 and the micro-controller 36. Thus, the display column elements in these “dumb icicle” signs are identical, and inexpensive.

Direct Data Transfer

Indirect transfer of column pattern data risks system failure for all micro-controllers downstream of any one micro-controller whenever that one micro-controller fails to properly forward the next column patter. This risk is offset when a secure, favorable operating and maintenance environment can be provided, as in FIG. 1, that makes such a failure only a remote possibility. However, the type of roof shown in FIG. 3 may provide no such conveniently-located, secure operational environment, so that the more direct approach to system control may be required. Also, the enclosures 12c, 12d, provided by the suspended display signs shown in FIGS. 4 through 4b provide only a limited amount of protected space. The direct approach is even more critically important for traveling-image signs that are in free space as in accordance with a third embodiment of the invention shown in FIGS. 5a-6b. Preferably the display-column elements 10 in these banners are “smart icicles” that each contain a micro-controller 36a.

FIG. 5e shows a suspended display column element 10 in accordance with the third embodiment of the invention exemplified by FIGS. 5a-5d. Each “smart icicle” display-column element 10 receives the same data from the master controller 36, but processes the data according to the offset of the location where the particular display-column element 10 is installed. Preferably, each suspended display column element 10 has a DIP switch unit 26b, or an EEPROM 28e, that is set by a technician when installing the display-column element 10 in the sign. The programming of the micro-controllers 36a in these display column elements 10 is then fully interchangeable, as well as being plug-replaceable, as further explained below with reference to FIG. 6a-6c.

FIG. 6a shows a display column 21 (D₁ to D₅) in each of five display-column elements 10 connected by respective hanging hardware 24c to data 40a and power 40b conductors. In FIG. 6a, at time t=7 column D₁ is lighting an image-column pattern (C₇) and has produced seven virtual columns that were lighted at times t=0 to t=6. At time t=8 column D₁ will be refreshing image-column pattern (C₈) that was lighted by column D₂ at time t=0.

The display-column elements 10 in FIG. 6a are supported by a single beam 50, similar to the pair of support beams 50, shown in FIG. 4b. In a practical traveling-image sign they would be only the last five display-column elements in the sign. For the sake of discussion, the traveling-image sign shown in FIG. 6a will be assumed to include only columns D₁ to D_{5,} whereas the image displayed by a practical traveling-image sign will be much longer.

Similarly, the image pattern stored by each microprocessor 36a in columns D₁ to D₅ will also be assumed to include only columns C₁ to Cᵣ, at most, whereas in practice the image stored may be much longer. The entire image pattern displayed at a given instant, will be assumed to include only columns C₁ to C₃₉, for the sake of simplicity. However, in FIG. 5c for example, the image pattern transmitted by the master controller 32 to the micro-controllers 36a may be divided into segments, for connected to respective segments (Sto S) of support-cable 50a, each cable segment receiving respective different data signals in parallel from the master controller 32 through respective towers 12d. Then the micro-controllers 36a connected to each cable segment (S₁ to Sₓ) will have a respective different stored image pattern (SC₁ to SCᵣ) and a corresponding respective displayed image pattern.

The image pattern stored by the micro-controllers 36a at a given time also includes several additional image-column patterns (Cᵣ) adjacent to the displayed image pattern (C₀ to C₃₉) on its upstream end (C₃₉), i.e., toward the injection end. These redundant columns (Cᵣ) are conventionally provided for the convenience in design implementation but, if the micro-controllers provide a recovery routine may also be used provide image-column patterns during transient conditions when data transmission is temporarily lost or compromised. Similarly, image-segment patterns (SC₀ to SCₓ) supplied to the respective micro-controllers 36 for each display segment may also include more image-column patterns (SC₀ to SCᵣ) than there are displayed image columns in the respective displayed image-pattern segment (SC₀ to SC₃₉.

In the micro-controllers 36a in display columns (D₁ to D₅), each time a new image-column pattern (Cₓ) for respective one of the display columns 21a-21d in a display-column element 10, or a respective new image-column pattern (S₁Cₓ to SₓCₓ) for each image segment Sₙ in FIG. 5a, is output by the master controller 32, a processor 36b in the micro-controller 36a in each of the display columns (D₁ to D₅) stores the new image-column pattern in the input buffer. In the particular micro-controller 36a shown in FIG. 6b, the stored image pattern (C₀ to Cₓ) is advanced by eight columns in the image data memory 36c, discarding the oldest column data (C₀ to C₇), and eight new-columns are added to the injection end (Cₓ₋₇ to Cₓ) of the stored image pattern (C₀ to Cₓ) each time an eighth new column is received by the input buffer from the processor 36b.

An EEPROM 28e, or a DIP switch unit 26b in the display-column element 10 cooperates with the counter 36d to track which image column is to be displayed by the pixels 20 of that display column 21 the next time a new column pattern is received by the input buffer from the processor 36b. Shifting the memory once for every (r) image-column patterns received may be beneficial for particular implementations. Alternatively, the micro-controller would have an EEPROM 28e, or DIP switch unit 26b but no counter 36d, updating the display column 21 from a static location in the memory that is determined by the EEPROM 28e, or DIP switch unit 26b and advancing the stored image pattern each time a new image-column is received.

Thus, in FIG. 6, the 32 daisy-chained micro-controllers 36 at most need to store only their respective adjacent image segments (Sₙ, where Sₙ=SS₁ through SSₓ) when they hand off image column patterns to each other, the “dumb-icicle” display column elements need no identifying code and only the pattern displayed by each column is transferred to the column 10. In contrast, the “smart-icicle” display column element shown in FIGS. 5e and 6b has a memory 36c that stores an entire image pattern (C₀ to C₃₉) that is displayed by an entire display sign or an entire cable segment in the display sign at a given time. Also, setting mechanical switches such as DIP switches 26b shown in FIG. 5e, or programming an EEPROM memory 28e in the “smart icicles” identifies the physical position of the display-column element 10 associated with each micro-controller 36a in the sign shown in FIG. 6a, when the column was first installed.

In a traveling-image sign having an 8:1 depopulation ratio, the stored column pattern data that is output through the memory buffer to the display column D₁ controlled by a given micro-controller 36a in a display column element 10 at a given time, is determined by the location code, and when the image pattern is updated each time (r) new image-column patterns are received, and the stored image is advanced or a depopulation offset value is provided by a 0-to-(r−1) counter 28d and the advance deferred, as described above. The respective input and output buffer space in each image data memory 36c is preferably at least large enough to store the image data for the image-column pattern that is displayed at any given time by a single display column Dₙ. In FIG. 6b, the output buffer holds one image-column pattern, but the input buffer stores the data for all eight image-column patterns that are shifted into the stored image pattern, each time eight image-column patterns have been received by the display column (Dₙ).

The micro-controller 36a in each display column element 10 samples the image pattern (C₀ to Cₓ) that is stored in image data memory 36c by a processor 36b in that micro-controller 36a, to select column pattern data representing the pixels that are to be displayed in one or more display columns 21 in the display column element 10 at a given time. The stored column-pattern data C₇ provided by the sampled data is then output to selectively light the pixels 20 in the respective display column (D₁), at t=7, as shown in FIGS. 6a and 6c.

Stored image-pattern data may be sampled literally, by sequentially providing image patterns representing the whole image pattern displayed at each instant in the image data memory 36c as the image advances, and then 1) selecting out each display-column image pattern (Cₙ) at one given location in the stored image pattern, for example (C₁), as it is due to be displayed by a given display column (D₁ In this example), or 2) buffering respective groups of column patterns corresponding to the display-column images (C₀ to C₇) displayed by the given display column (D₁) before the stored image-pattern is shifted, or 3) virtually selecting each display-column image pattern as it is due, or each group of column patterns by applying circular buffer techniques well-known in the art to select from the displayed image column patterns from a sequence of locations in a given stored image patten (C₀ to Cₓ).

Although memory contents corresponding to display columns (D₁ to D₄) downstream from a given display column (D₅) are of no use to the micro-controller 36a for that given display column (D₅), it is advantageous for the image data memory 36c in each display column element 10 to have enough storage capacity to hold the contents of a respective input and output buffer space, system commands, and the entire image pattern displayed by the traveling image sign at any given time, so that all the plug-replaceable column elements 10 are fully interchangeable with each other—they can even be installed in the position farthest downstream. Preferably, the column patterns (C₀ to Cₓ) stored in the image data memory 36c also include one or more redundant (Cᵣ) newly-added image-column patterns. The respective input and output buffer space in each image data memory 36c is also preferably at least large enough to store the image-column data that is displayed at any given time by a single display column 21, as shown schematically in FIGS. 6b-6c.

The image data memory 36c in each display-column element 10 of the depopulated banner shown in FIG. 5a, which has a respective pixel color 20r, 20g, 20b, is similar. However, since the column elements 10 have respective pixel colors 20r, 20g, 20b, although the elements 10 all receive the same column pattern data, each one preferably stores only the color-separation image pattern and new image-column data for its respective image-column color, Cr, Cg, Cb. Thus, the display column elements are interchangeable with others of the same color. The depopulation ratio for each of these one-color color-separation images, that are formed by the three depopulated sets of like display columns for red (D_{1,} D₄), green (D_{2,} D₅), and blue (D_{3,} D₆), having respective linear arrays of like-color display pixels 20r, 20g, 20b, in respective and that combine to produce a three-color traveling-image display in FIG. 5a, is preferably a multiple of three, 3:1 or greater.

If the depopulation ratio in FIG. 5a is 9:1, for example, the columns Dₙ in the sign may be timed so that a red display-column image Cr₉ that is lit by red column D₁ at time t=9 corresponds to the perceived position of the green virtual display-column image Cg₆ that was lit by green column D₂ at time t=6 and the perceived position of the blue virtual display-column image Cb₃ that was lit by blue column D₃ at time t=3. This timing produces a sequence of perceived multi-colored columns of pixels at D₁ having a range of colors produced by respective individual combinations of these additive primary colors.

Similarly, Cr₈ would overlay the perceived positions of Cg₅ and Cb₂, and so on. If sufficient data channel bandwidth is available, the range of colors produced by these color overlays in each perceived pixel may be expanded by varying the brightness of each colored pixel in each display column (D). Thus the respective (t₀ to tₓ) offset times at which corresponding columns in any given number (c) of respective color separation image patterns will be displayed will be integer (n) multiples of r/c such that t₀=0, t₁=nr/c, and tₓ=nrx/c where (r) is the value of the depopulation ratio.

Free-Space Power Distribution

Although bandwidth constraints are more problematic for depopulated traveling-image signs that are suspended in free space, than for other embodiments of the invention because of the long, exposed cable runs 50a that they often require, these cable run lengths are more problematic for power than for data. Low-voltage DC power must be provided to the circuits of individual display column elements 10, but the power distribution lines supplying the individual display column elements 10, whether AC or DC, must be run and fused at conservative amperage values to comply with applicable building codes. Because very long power cables may draw more current than is permitted in a single fused circuit, a cable assembly 50a for the suspended signs preferably provides support and shrouding for multiple, fused circuit conductors.

The cable assembly 50a also provides facilities for breaking out the circuit or circuits needed for each display column element 10 at respective locations along the cable 50a in a suitable manner well-known in the art. Preferably the break out is implemented by a tap bar (not shown) having secure, recessed threaded or spring driven contact points that engage a tap plug (not shown), attached to the connector leads 40b on the display column element 10 inside suitable hanger hardware 24c that is integrated onto the element 10 near the micro-controller 36a. Alternatively, contact can be made using an exposed longitudinal contact strip molded onto the cable, or by providing insulation-piercing contacts in a tap plug inside the hanger 24c.

If data from the master controller is to be delivered using separate hard-wired data circuits 40a, these data conductors will also be included in the tap bar on the cable assembly 50a and on the connector leads 30 shown in FIG. 5e. Alternatively, data can be extracted without contacting the data conductors 40a in the cable 50a by inductive or capacitive pickups, or the data can be carried on the power conductors by RF or intermediate frequency carrier waves. If the cable assembly 50a provides only power 40b, the data can be readily distributed by RF or IR links. Preferably, the display column pattern data would be broadcast to all the display columns by a line-of-sight RF or IR data signal transmitter, with more than one copy of the incremental display pattern data being injected directly into all the display column elements 10, thereby providing a high degree of data redundancy and independent operation for the display column elements while using low-bandwidth broadcast technology.

Limitations on the capabilities of the micro-controllers 36a in this system and on the power which can be delivered through one cable in signs such as those depicted in FIGS. 5a-5f will determine the maximum cable span that can be used. If this length is insufficient to meet a particular requirement, multiple separate cable spans may be used, draped between towers or overhead suspension points as shown in FIGS. 5c and 5d with each cable span functioning as a complete sign and receiving data from the master controller 32 via a separate channel connection. Time delays generated within the master controller 32 will cause the independently functioning cable span signs to appear as if they were all one sign.

Additional Design Options

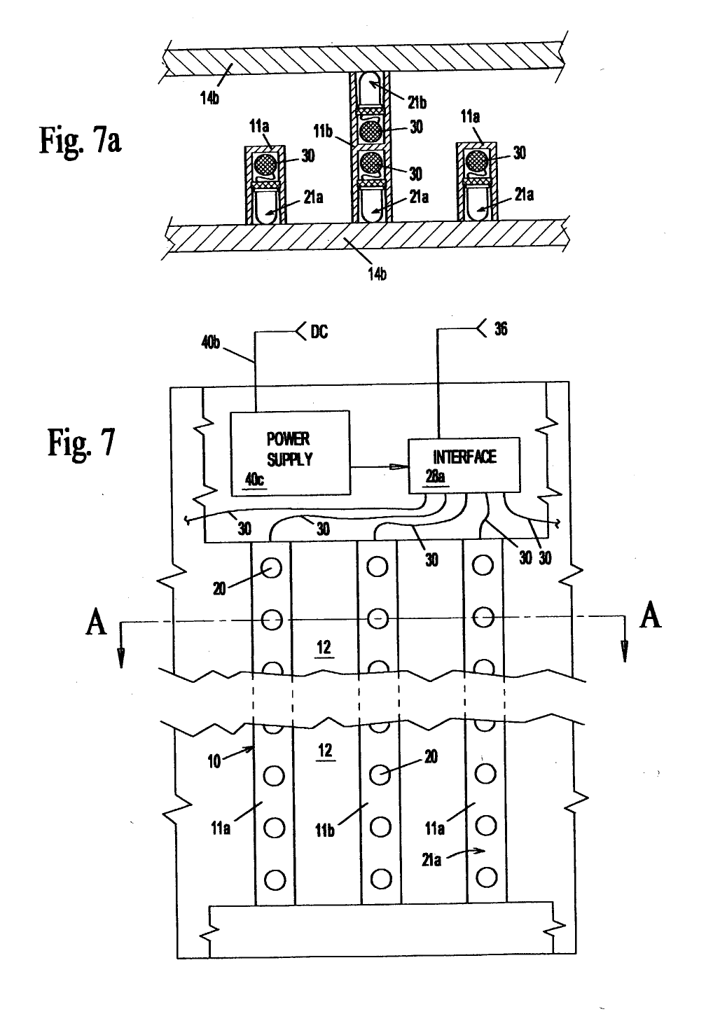

Alternatively, display column elements 10 may be mounted at eye level, flush with or recessed behind the level of an adjacent surface 12 as shown in FIG. 7, or in free-standing floor-mounted columns as shown in FIG. 7a. In FIGS. 7 and 7a, the display-column elements 10 shown are “dumb icicles” that may be plug-replaceable, in which case they will also be plug replaceable.

If the display columns 21 shown in FIG. 7 are recessed into the adjacent surface 12, they will not be viewable from an oblique angle. Because they are not viewable from an oblique angle, static image patterns displayed by these depopulated display columns 21 may be unintelligible, unless the viewer can see them from a distance.

FIG. 7a shows display columns 21a, 21b, facing respective sides of a transparent wall 14b, that are supported by two types of vertical extruded channels 11a, 11b. The columns 21a, supported by one-sided channels 11a and two-sided channels 11b in alternation, are spaced apart on 25.4 mm centers and can be used to display both static and virtual traveling images having a wide viewing angles.

In contrast, the display columns 21b on the other side of the two-sided channels 1b are twice as widely spaced. If the display pixels within each of the channels 11a are spaced apart on 12.7 mm centers, the depopulation ratio is 2:1, but the effect of this depopulation is sufficiently mild that the display pixels also display static images fairly well. Even at an 8:1 depopulation ratio, static text may be made legible if a very large font is used or if a smaller font is stretched by a factor of 8. When a small font is stretched by a factor of 8, it is surprisingly easy to read if viewed at an oblique angle.

The invention has been described with reference to particular presently preferred embodiments thereof. However it will be apparent to one skilled in the art that additional variations and modifications thereof are possible within the spirit and scope of the invention exemplified by these embodiments. For example, only a given segment of each like display column may participate in a given one-color color-separation image, and other segments of the like display columns and like image columns may participate in other color-separation images or provide white light, or like display columns and like image columns may participate in other types of additive-color images. The invention is defined by the appended claims.

1-20. (canceled)

21. A traveling-image display sign having a plurality of display pixels and a controller, each display pixel having at least one light source, the controller including means for storing at least one image pattern and including means for selectively supplying power to the light sources so as to sequentially display image patterns representing a stored image pattern on the plurality of light sources, each stored image pattern including a plurality of image-columns having respective image-column patterns, each image-column pattern providing a linear array of image-pattern pixels, each image-pattern pixel in an image-column pattern being an image-pattern pixel in a respective row of image-pattern pixels, said sign comprising:
a plurality of display-column elements, each display-column element supporting a display column, each display column providing an array of display pixels, said display columns in respective display-column elements being spaced apart by respective inter-columnar distances, a display pixel in each of said display columns in respective display-column elements being disposed in an array corresponding to a respective row of display pixels, said display columns in respective display-column elements having a physical pixel-aspect index (p) of ½ or less (p≦½), said physical pixel-aspect index (p) being the value of a ratio of the average intra-columnar distance between adjacent like display pixels in a display column to the average inter-columnar distance between adjacent display, pixels in respective rows of adjacent display pixels in adjacent like display columns in respective display-column elements; and
means for selectively supplying power to light sources in selected display pixels in each display column in respective display-column elements so as to sequentially display image-column patterns of a given plurality of adjacent like image column patterns in an image pattern displayed by the display sign before an image column in said given plurality of adjacent like image columns is displayed by a next adjacent like display column.

22. The display sign of claim 21 further comprising a power connector and a supporting link at one end of a display column element, said display column element being plug-replaceable.

23. The display sign of claim 22, wherein said plug-replaceable display column element is interchangeable with other display column elements in the display sign.

24. The display sign of claim 21, further comprising at least one support cable, a plurality of said display column elements being supported by said support cable.

25. The display sign of claim 21 further comprising a breakaway link adapted to support a display column element in a horizontal position.

26. The display sign of claim 21 further comprising independently-controlled light sources of respective different types in a display pixel.

27. The display sign of claim 26 further comprising means for selectively varying power supplied to light one of said types of light sources in said display pixel relative to the power supplied to light other light sources in each display pixel, to selectively vary the additive color provided by said display pixel.

28. The display sign of claim 21 further comprising:
means for storing image patterns of two or more (c) types (Tₓ=T₁ to T_{c}) of image patterns, said display column, elements having display columns of said respective types (T₁ to T_{c}), said means for selectively supplying power to light sources being adapted to selectively supply power to light sources in selected display pixels in each display column of a respective type so as to sequentially display corresponding image-column patterns in image patterns of each respective type on display columns of said respective types; and
means for displaying image patterns of each type (T₁ to T_{c}) being displayed at a respective relative offset time (tₓ=t₀ to t_{c-1}) that is an integer (n) multiple of r such that tₓ=nrx, so that said corresponding image-column patterns in image patterns of said respective types appear to be overlaid.

29. The display sign of claim 21, wherein each display-column element supports a display column of a respective one of types Tₓ, each display pixel in a row of display pixels having a color corresponding to a respective type Tₓ of display pattern, display columns of respective types Tₓ displaying respective stored images and alternating in each row of display pixels so that the depopulation ratio value (r) for each of (c) different types of display columns is a respective integer (nₓ) multiple of (c) so that (r=cnₓ) for a given image displayed by a corresponding type Tₓ of display column.

30. The display sign of claim 28 further comprising means for selectively varying the power-supplied to a light source in a display pixel representing an image pixel in a respective type of image pattern relative to the power supplied to a light source in another display pixel representing an image pixel in said image pattern of said respective type, so as to selectively vary the additive effect of corresponding image-pattern pixels in different types of image patterns that appear to be overlaid.

31. The display sign of claim 30, wherein said two or more image patterns of respective types are respective color-separation image patterns.

32. The display sign of claim 30, wherein said display columns of respective types alternate in a row, and display columns of respective types provide pixels of respective additive colors.

33. The display sign of claim 31 further comprising a respective one of three additive complementary in each of said display columns, and wherein the depopulation ratio value (r) for each of the three different color-separation image patterns is an integer (n) multiple of 3 (r=3n).

34. The display sign of claim 21 further comprising a micro-controller in each display column element, said micro-controllers cooperating with the controller to selectively light display pixels in a respective display column element so as to represent one or more image-column patterns provided by the controller to said micro-controller.

35. The display sign of claim 34 further comprising local storage means for storing an image pattern in said micro-controller, said image pattern having image-column patterns provided by the controller to the micro-controller, said micro-controller being adapted to selectively light display pixels in said display column element corresponding to stored image-column patterns provided by the controller to said micro-controller.

36. The display sign of claim 35, further comprising address input means for identifying which image-column patterns in an image pattern stored in local storage means are to be displayed by a display column in each given display column element.

37. The display sign of claim 21 further comprising sensing means for sensing ambient light, said sensing means being connected to the controller, said controller modifying the power provided to said light sources in response to said sensor means.

38. The display sign of claim 21 wherein the display sign is a traveling-image display sign adapted to selectively supply power to the light sources so as to display a sequence of image patterns on the plurality of light sources, said displayed image patterns each representing a respective stored image pattern, and wherein said display-column elements are discrete display-column elements, said means for selectively supplying power to light sources in selected display pixels being adapted to sequentially display image-column patterns of a given plurality of adjacent like image columns in the image pattern displayed by the display sign, in a given adjacent like display column, before an image column pattern in said given plurality of adjacent like image columns is displayed by a next adjacent like display column, said given adjacent like display column displaying an image-column pattern of an image column in a next given plurality of adjacent like image column patterns while said next adjacent like display column displays said image column pattern of said image column in said given plurality of adjacent like image columns.

39. A method of illuminating a traveling-image display sign having a plurality of display pixels in display columns, each display column providing a linear array of display pixels, each of the display pixels having at least one light source, a display pixel in each of said display columns being disposed in a linear array corresponding to a respective row of display pixels, said display sign having at least one stored image pattern, each stored image pattern including a plurality of image-column patterns, each image-column pattern providing a linear array of image-pattern pixels, each image-pattern pixel in an image-column pattern being an image-pattern pixel in a respective row of image-pattern pixels, said method comprising the steps of:
providing a plurality of display-column elements, each display-column element supporting a display column, said display columns have a physical pixel-aspect index (p) of ½ or less (p≦½), said physical pixel-aspect index (p) being the value of a ratio of the average intra-columnar distance between adjacent like display pixels in a display column to the average inter-columnar distance between adjacent display pixels in respective rows of adjacent display pixels in adjacent like display columns; and
selectively supplying power to light sources in selected display pixels in each display column so as to sequentially display image-column patterns of a given plurality of adjacent like image column patterns in the image pattern displayed by the display sign before an image column in said given plurality of adjacent like image columns is displayed by a next adjacent like display column.

40. The method of claim 19 wherein said sign has image patterns of two or more respective types (Tₓ=T₁ to T_{c}) and said step of selectively supplying power comprises:
selectively supplying power to light sources in selected display pixels in each display column so as to sequentially display corresponding image-column patterns in image patterns of respective types, like image patterns of each type (Tₓ) being displayed at a respective relative offset time (tₓ=t₀ to t_{c-1}) that is an integer (n) multiple of r such that tₓ=nrx, so that said corresponding image-column patterns in image patterns of respective types appear to be overlaid.

41. A display of an image pattern on a traveling-image display sign, said image pattern including a plurality of adjacent like image-columns having respective image column patterns, each image-column pattern providing a linear array of image-pattern pixels, each image-pattern pixel in an image-column pattern being an image-pattern pixel in a respective row of image-pattern pixels, said display being-produced by a method comprising the steps of:
providing rows of display pixels and a plurality of display-column elements, each display-column element supporting a display-column, said display-column providing a linear array of display pixels, said display columns in respective display-column elements being spaced apart by respective inter-columnar distances, a display pixel in each of said display columns being disposed in a linear array, said linear array of display pixels from each of said display columns corresponding to a respective one of said rows of display-pixels;
selecting an image pattern;
illuminating light sources in selected display pixels in a given display column so as to sequentially display a plurality of display-column patterns representing a respective plurality of adjacent like image columns in said selected image pattern in response to said selected image pattern, said given display column displaying at least two image-column patterns of said image pattern before displaying image-column patterns of a next image pattern, and said display sign having a physical pixel-aspect index of ½ or less (p≦½), said physical pixel-aspect index (p) being a ratio of the average intra-columnar distance between adjacent like display pixels in a display column to the average inter-columnar distance between adjacent display columns having like display pixels, like image-column patterns being image-column patterns of similar-color image-pattern pixels and like display columns being display columns of pixels having similar-color light sources.
